(19) United States
(12) Patent Application Publication
(10) Pub. No.: US 2007/0280150 A1
(43) Pub. Date: Dec. 6, 2007

(54) METHOD FOR PROVIDING AN INDICATION OF MULTIPLE CARRIERS TO A MOBILE UNIT

(76) Inventors: Ashok N. Rudrapatna, Basking Ridge, NJ (US); Jialin Zou, Randolph, NJ (US)

Correspondence Address: Mark W. Sincell, Ph.D.;Williams, Morgan & Amerson, P.C., Suite 1100, 10333 Richmond, Houston, TX, 77042, US

(21) Appl. No.: 11/421,870

(22) Filed: Jun. 2, 2006

(51) Int. Cl. H04Q 7/00

(52) U.S. Cl. 370/328

(57) ABSTRACT

The present invention provides a method of wireless communication. One embodiment of the method includes providing a message including information indicative of at least one carrier and at least one system type associated with each carrier. Another embodiment of the method includes receiving a message including information indicative of at least one carrier and at least one system type associated with each carrier.

### BACKGROUND OF THE INVENTION

1. Field of the Invention

This invention relates generally to communication systems, and, more particularly, to wireless communication systems.

2. Description of the Related Art

The coverage area of a wireless communication system is typically divided into a number of cells, which may be grouped into one or more networks. Base stations associated with the cells provide wireless connectivity to mobile units in the cell or in a sector of the cell. The mobile units may include devices such as mobile telephones, personal data assistants, smart phones, Global Positioning System devices, wireless network interface cards, desktop or laptop computers, and the like. Mobile units located in each cell may access the wireless communications system by establishing a wireless communication link, often referred to as an air interface, with a base station associated with the cell. Information may be transmitted over the air interface using a carrier, such as a high frequency radio sinusoid waveform that is modulated based on the information to be transmitted by the carrier. Each base station may support more than one carrier and mobile units located at a specific position may be able to access carriers provided by more than one base station.

In some activity states, such as the idle or dormant mode or when the mobile unit has been powered down, the mobile unit may not maintain an active connection and the air interface to the base station may be torn down. When the mobile unit wakes up it may listen for an overhead message broadcast by base stations that are serving the cell or sector that contains the mobile unit. Conventional overhead messages typically include information such as a list of the existing carriers for the sectors or cells served by the base stations broadcasting the overhead message. The mobile unit may then attempt to form a wireless communication link with the base station by hashing the carriers indicated in the overhead message. Hashing is a technique that may be used by a mobile unit or an access network to pseudo-randomly choose a carrier from a group of available carriers.

Conventional overhead messages do not, however, include information that indicates the carriers that are provided in a sector by each type of system. For example, a conventional wireless communication system may include some base stations that operate according to Revision-B and/or Revision-C of the CDMA2000 EVDO standards. Revision-C is a later revision than Revision-B and so mobile units that support Revision-B may or may not also support Revision-C, and vice versa. Since the conventional overhead message does not include information indicating which revision of the EVDO standards supports each of the carriers, idle mobile units that are attempting to form a wireless communication link may hash one or more carriers that operate according to a revision that is not supported by the mobile unit. These futile hashing attempts represent wasted overhead.

Conventional overhead messages also do not include information that indicates whether the existing carriers are available or overloaded. For example, an overhead message received by an idle mobile unit may indicate that first and second carriers exist in the sector where the mobile unit is located. The mobile unit may hash both carriers. However, if the first carrier is overloaded and is selected by the mobile unit, the mobile unit will fail to get access and establish a connection with the network through the first carrier. The conventional overhead message will not inform the mobile unit that the first carrier is overloaded and so the mobile unit may be hashed on the overloaded first carrier. The selection of the first carrier will almost certainly fail the access and admission efforts, resulting in wasted system resource and increased delay. On the other hand, a second carrier that has a relatively low load and hashes on the second carrier would very likely gain access, permitting the mobile unit to establish a wireless communication link.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for wireless communication. One embodiment of the method may include providing a message including information indicative of at least one carrier and at least one system type and per priority class based carrier availability associated with each carrier. Another embodiment of the method may include receiving a message including information indicative of at least one carrier and at least one system type and per priority class based carrier availability associated with each carrier.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 conceptually illustrates one exemplary embodiment of an overhead message, in accordance with the present invention;

FIG. 3 conceptually illustrates one exemplary embodiment of a method for using system type information provided in an overhead message, in accordance with the present invention; and

FIG. 4 conceptually illustrates one exemplary embodiment of a method for hashing overlaid carriers of different system types, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

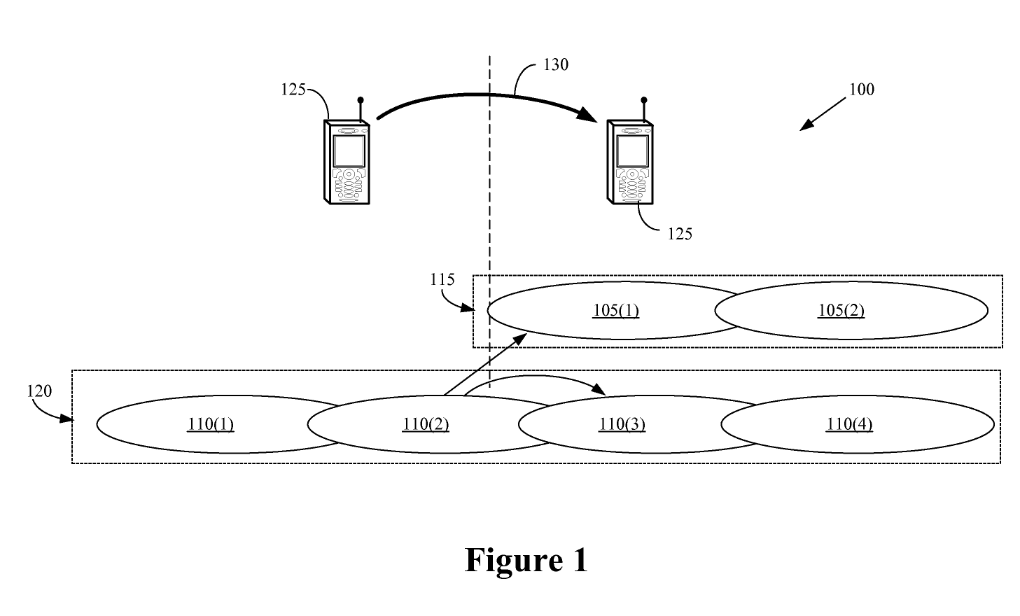

FIG. 1 conceptually illustrates a first exemplary embodiment of a wireless communication system 100. In the illustrated embodiment, the wireless communication system 100 provides wireless communication to a plurality of geographic areas or cells 105(1-2), 110(1-4). The numerical indices may be dropped when referring to the cells 105, 110 collectively. However, the numerical indices (1-2), (1-4) may be used to indicate individual cells 105, 110 and/or subsets of the cells 105, 1 10. This numbering convention may be applied to elements depicted in other figures and distinguished by different numerical indices. Persons of ordinary skill in the art having benefit of the present disclosure should appreciate that the wireless connectivity may be provided to the cells 105, 110 using one or more base stations, base station routers, access points, and the like, as well as controllers such as radio network controllers, although these entities and/or devices are not shown in FIG. 1. Persons of ordinary skill in the art having benefit of the present disclosure should also appreciate that the number of cells 105, 110 shown in FIG. 1 is intended to be illustrative and not to limit the present invention.

The cells 105, 110 are differentiated as layers 115, 120 that implement different system types. In one embodiment, the system protocol types implemented in the layers 115, 120 are distinguished by a protocol revision of a wireless air interface standard used to provide wireless connectivity over the carriers supported by the cells in the layers 115, 120. For example, layer 115 may operate according to Revision-C of the EVDO standard and layer 120 may operate according to Revision-B of the EVDO standard. As used herein, the terms “standard or protocol revision” will be understood to refer to revisions of a wireless communication standard or protocol that are implemented in (or supported by) successive generations of wireless communication equipment. One characteristic of a standard or protocol revision is that wireless communication equipment that was originally designed only to support an earlier, or legacy, revision is typically not able to communicate using later revisions of the standard or protocol. In contrast, wireless communication equipment that is designed to support later revisions may also be able to support legacy revisions of the standard or protocol, e.g., wireless communication equipment may be backwards compatible with legacy revisions of the standards or protocols.

The system types implemented in the layers 115, 120 may also be distinguished by frequencies of the carriers used provide wireless connectivity and/or the radio access technology used to provide wireless connectivity. For example, in a wireless communication system 100 that operates according to EVDO Rev-B standards and/or protocols, wireless connectivity may be provided to the cells 105 using a first carrier frequency and to the cells 110 using a second carrier frequency. For another example, wireless connectivity may be provided to the cells 105 according to UMTS standards and/or protocols and wireless connectivity may be provided to the cells 110 according to EVDO Rev-C standards and/or protocols.

The wireless communication system 100 provides wireless connectivity to one or more mobile units 125. Only one mobile unit 125 is shown in the illustrated embodiment, however, persons of ordinary skill in the art having benefit of the present disclosure should appreciate that any number of mobile units 125 may operate within the wireless communication system 100. Persons of ordinary skill in the art having benefit of the present disclosure should also appreciate that the mobile units 125 may be referred to using other terms of art such as “user equipment,” “mobile stations,” “subscriber units,” “subscriber stations,” and the like. Exemplary mobile units 125 may include, but are not limited to, devices such as mobile telephones, personal data assistants, smart phones, Global Positioning System devices, wireless network interface cards, desktop or laptop computers, and the like.

The mobile unit 125 may be capable of communicating with cells 105, 110 in one or both of the layers 115, 120. For example, the mobile unit 125 may be a backwards-compatible Rev-C-EVDO device that is capable of communicating using carriers provided by cells 105 according to Revision-C of the EVDO standard and carriers provided by cells 110 according to Revision-B of the EVDO standard. For another example, the mobile unit 125 may be a Rev-B-EVDO device that is not capable of communicating using carriers provided by cells 105 according to Revision-C of the EVDO standard, but is capable of communicating using carriers provided by cells 110 according to Revision-B of the EVDO standard.

The mobile unit 125 is initially associated with the cell 110(2). The mobile unit may therefore access the wireless communication system 100 via the cell 110(2) and receive information from the wireless communication system 100 via the cell 110(2), e.g., according to Revision-B of the EVDO standard. Techniques for transmitting information to the mobile unit 125 and/or receiving information from the mobile unit 125 over air interfaces established between the mobile unit 125 and the cell 110(2) are known to persons of ordinary skill in the art and an interest of clarity only those aspects of transmitting information over the air interface that are relevant to the present invention will be discussed further herein. The mobile unit 125 may then power down or enter an inactive mode such as an idle mode or a dormant mode. The air interface with the cell 110(2) may therefore be torn down when the mobile unit 125 becomes inactive.

In the illustrated embodiment, the inactive mobile unit 125 moves into a geographic area or sector served by base stations in the (at least partially) overlapping cells 105(1) and 110(3). However, this embodiment is intended to be illustrative and not to limit the present invention. In alternative embodiments, the mobile unit 125 may not necessarily move or roam. For example, the inactive mobile unit 125 may remain in a location or sector that is served by base stations in the cell 110(2). For another example, the inactive mobile unit 125 may remain in approximately the same location but may nevertheless become associated with different cells due to changes in environmental conditions or network configurations that may extend, reduce, or otherwise modify coverage areas associated with the cells 105, 110 or other cells not shown in FIG. 1.

The inactive mobile unit 125 may then enter an active state and attempt to form a wireless communication link with one of the cells 105(1) and 110(3). Upon (or during) entry into the active state, the mobile unit 125 may receive one or more overhead messages provided by the cells 105(1) and 110(3). The overhead message(s) include a list of the carriers provided by the cells 105(1) and 110(3) and the system types associated with these carriers. For example, the overhead message may include a list of one or more Rev-C-compatible carriers provided by the cell 105(1) and one or more Rev-B-compatible carriers provided by the cell 110(3). In one embodiment, the overhead message may also include information indicating whether or not the listed carriers are available, e.g., the list may indicate whether the carriers are currently overloaded.

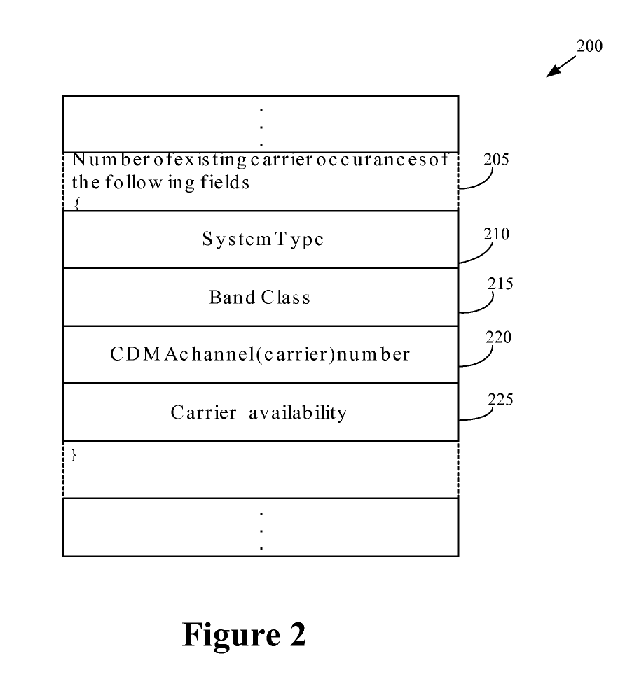

FIG. 2 conceptually illustrates one exemplary embodiment of an overhead message 200. In the illustrated embodiment, the overhead message 200 includes a field 205 that indicates the total number of carriers in the sector that receives the overhead message 200. The overhead message 200 also includes a set of fields 210, 215, 220 for each of the existing carriers. The fields 215, 220 indicate the band class of the carrier and the CDMA channel or carrier number of the carrier, respectively. The field 210 indicates the system type of the associated carrier. For example, the field 210 may indicate that the associated carrier operates according to either Revision-B or Revision-C of the EVDO standard. However, as discussed above, the fields 210 may also indicate other system types associated with the carrier. In one embodiment, the overhead message 200 includes a field 225 that indicates availability of the associated carrier. For example, the field 225 may include information indicating whether the carrier is overloaded. Alternatively, the field 225 may include information indicating a current loading of the carrier.

Referring back to FIG. 1, the mobile unit 125 may attempt to hash one or more of the carriers provided by the cells 105(1) and 110(3) and indicated in the overhead message. For example, if the mobile unit 125 is a backwards-compatible Revision-C device and if there are Rev-C carriers available for hashing, then the mobile unit 125 may form a list including only the Revision-C carriers. If there are no Rev-C carriers available for hashing then the mobile unit 125 may form a list of Revision-B carriers indicated in the overhead message. If the overhead message includes information indicating whether or not some of these carriers are available, the mobile unit 125 may exclude the unavailable or overloaded carriers from the list of candidate carriers. The mobile unit 125 may then attempt to hash one or more of the carriers in the list. For example, the mobile unit 125 may choose a carrier by hashing from the list. The mobile unit 125 may first attempt to hash the Revision-C carriers and then attempt to hash the Revision-B carriers if none of the Revision-C carriers are available.

In one embodiment, the availability of carriers may be indicated in the overhead message based on the loading of the carriers for different priority classes of mobile units 125 or calls. For example, the overhead message may include information indicating that some carriers are not available to low priority users or calls. However, the overhead message may also include information indicating that these carriers are available to medium or high priority user or calls. For another example, the overhead message may include information indicating that some carriers are not available to low or medium priority users or calls. However, the overhead message may also include information indicating that these carriers are available to high priority users or emergency calls.

The mobile unit 125 may use the priority information included in the overhead message to select carriers for hashing. For example, during the initial call set up of the mobile unit 125, or when the mobile unit 125 is paged but its default carrier is overloaded and not available, the mobile unit 125 may only hash the group of carriers available to its own priority class. For example, if the mobile unit 125 is operating at a high priority (e.g., for emergency communications or because the user has paid for higher priority access) may first attempt to hash the Revision-C carriers. If the mobile unit 125 is not able to hash one of the high priority Revision-C carriers, the mobile unit 125 may attempt to hash one or more lower priority carriers. However, if the mobile unit 125 is operating in a relatively low priority (e.g., for non-emergency communications or because the user has paid less for lower priority access), the mobile unit 125 may be restricted to hashing the Revision-B carriers. Lower priority users may also be moved or downgraded to legacy carriers to alleviate loading on carriers operating according to the most recent revision.

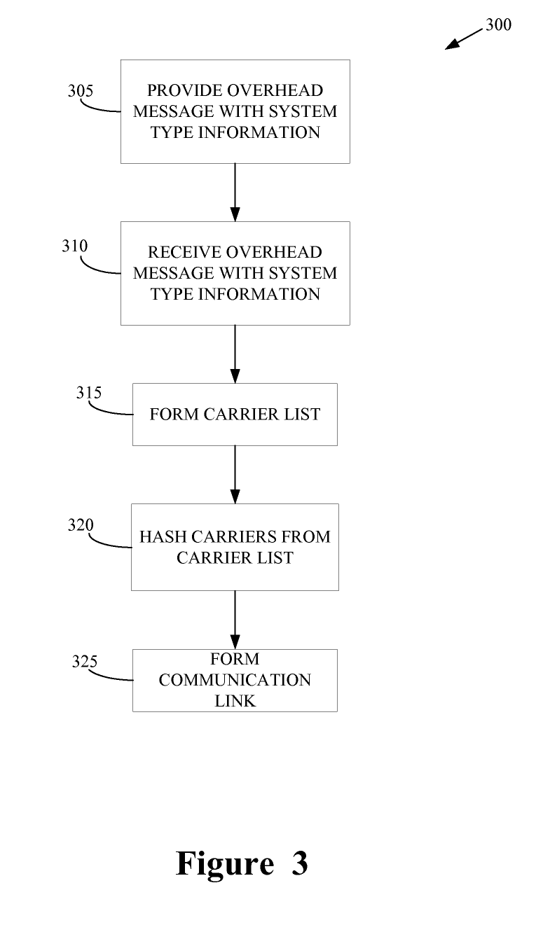

FIG. 3 conceptually illustrates one exemplary embodiment of a method 300 for using system type information provided in an overhead message. In the illustrated embodiment, an overhead message is provided (at 305), e.g., by a base station that provides wireless connectivity using one or more carriers. As discussed above, the overhead message includes information indicating system types for each of the existing carriers. In some embodiments, the overhead message may also include information indicating whether or not the carriers are available and/or overloaded for different priority classes. A mobile unit receives (at 310) the overhead message. For example, an idle mobile unit may receive (at 310) the overhead message following (or during) entry into an active state.

The mobile unit then forms (at 315) a list of the available carriers. For example, if the mobile unit is a Revision-C-compatible device, the carrier list may include all of the carriers that operate according to Revision-C, as well as the carriers that operate according to Revision-B if the mobile unit is backwards compatible. The mobile unit hashes (at 320) carriers from the carrier list until one of the hashes succeeds and the mobile unit is able to form (at 325) a communication link using the hash to carrier.

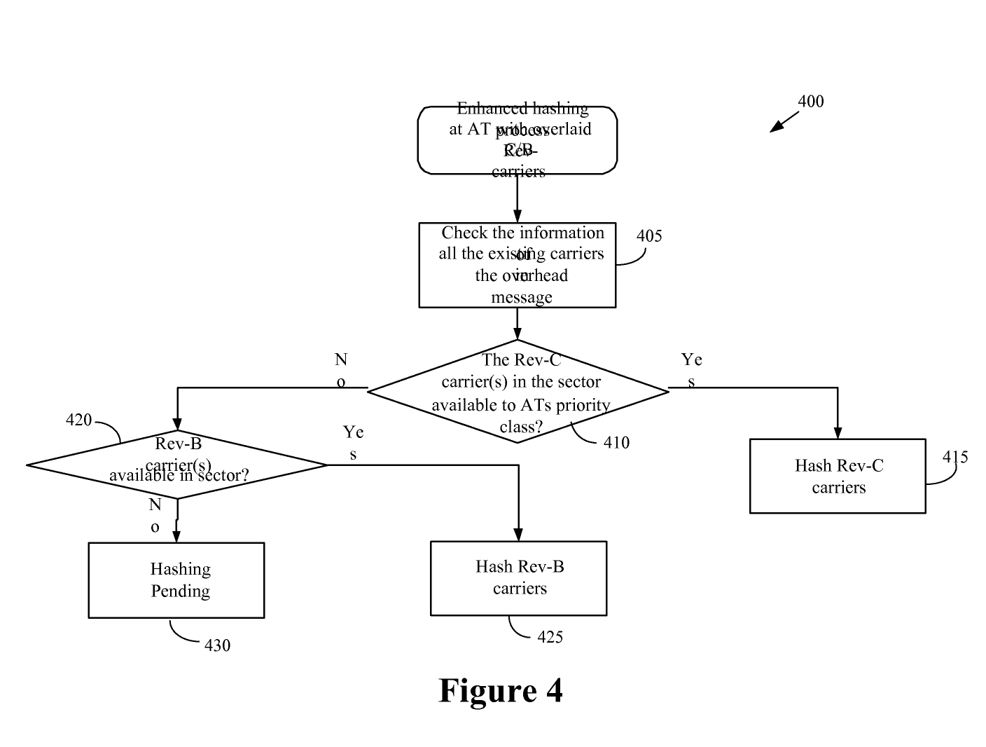

FIG. 4 conceptually illustrates one exemplary embodiment of a method 400 for hashing overlaid carriers of different system types. In the illustrated embodiment, the overlaid carriers are assumed to be Revision-B/C carriers, although the present invention is not limited to these particular system types. The method 400 is assumed to be implemented in a backwards-compatible Revision-C mobile unit. The mobile unit checks (at 405) the information associated with the existing carriers indicated in an overhead message received by the mobile unit. If the overhead message indicates (at 410) that one or more Revision-C carriers are available in the sector including the mobile unit, then the mobile unit may hash (at 415) the Revision-C carriers. If the overhead message indicates (at 410) that no Revision-C carriers are available to the priority class associated with the mobile unit in the sector covering the mobile unit, but the overhead message indicates (at 420) that one or more Revision-B carriers are available, then the mobile unit may hash (at 425) the indicated Revision-B carriers. If the overhead message indicates (at 420) that no Revision-B carriers are available to the priority class associated with the mobile unit, then the hashing may be left pending (at 430).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication, comprising:
providing a message including information indicative of at least one carrier and at least one system type associated with each carrier.

2. The method of claim 1, wherein providing the information indicative of at least one system type associated with each carrier comprises providing information indicative of at least one of a protocol revision and a standard revision associated with each carrier.

3. The method of claim 1, wherein providing the message comprises providing a message including information indicative of at least one level of availability of each carrier.

4. The method of claim 3, wherein providing the message comprises providing a message including information indicative of at least one call priority class of each carrier.

5. The method of claim 4, wherein providing the message comprises providing information indicating whether each carrier is available for mobile units having a selected call priority class.

6. The method of claim 1, further comprising receiving at least one hash attempt in response to providing the message.

7. The method of claim 6, wherein receiving said at least one hash attempt comprises receiving at least one hash attempt determined based on the information indicative of said at least one carrier and at least one system type associated with each carrier.

8. The method of claim 6, wherein receiving said at least one hash attempt comprises receiving at least one hash attempt based on information indicative of availability of said at least one carrier to mobile units having a selected priority class.

9. The method of claim 6, wherein receiving said at least one hash attempt comprises receiving at least one hash attempt based on a priority associated with a mobile unit.

10. The method of claim 6, comprising establishing at least one wireless communication link with a mobile unit based on said at least one hash attempt.

11. A method of wireless communication, comprising:
receiving a message including information indicative of at least one carrier and at least one system type associated with each carrier.

12. The method of claim 11, wherein receiving the information indicative of at least one system type associated with each carrier comprises receiving information indicative of at least one of a protocol revision and a standard revision associated with each carrier.

13. The method of claim 11, wherein receiving the message comprises providing a message including information indicative of availability of each carrier.

14. The method of claim 13, wherein receiving the message comprises receiving a message including information indicative of at least one call priority class of each carrier.

15. The method of claim 14, wherein receiving the message comprises receiving information indicating whether each carrier is available for mobile units having a selected call priority class.

16. The method of claim 11, comprising selecting at least one carrier based on the information indicative of at least one carrier and at least one system type associated with each carrier.

17. The method of claim 16, wherein selecting said at least one carrier comprises selecting at least one carrier based on information indicative of availability of said at least one carrier to mobile units having a selected priority class.

18. The method of claim 16, wherein selecting said at least one carrier comprises selecting said at least one carrier based on a priority class.

19. The method of claim 16, further comprising forming a group of carriers for hashing in response to receiving the message.

20. The method of claim 19, wherein providing said at least one hash attempt comprises providing at least one hash attempt for said at least one selected carrier in the group.

21. The method of claim 19, comprising establishing at least one wireless communication link with the selected carrier based on said at least one hash attempt.
